(19) United States
(12) Patent Application Publication
(10) Pub. No.: US 2009/0019307 A1
(43) Pub. Date: Jan. 15, 2009

(54) DIGITAL BROADCAST FILE DATA RECEIVING METHOD AND APPARATUS

(75) Inventor: Seoung Geun KWON, Daegu Metropolitan City (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/143,690

(22) Filed: Jun. 20, 2008

(30) Foreign Application Priority Data
Jul. 9, 2007 (KR) 2007-0068605

(51) Int. Cl. G06F 11/14

(52) U.S. Cl. 714/16; 714/E11.112

(57) ABSTRACT

A digital broadcast file data receiving method and a digital broadcast file data receiving apparatus are provided. The digital broadcast file data receiving method and the digital broadcast file data receiving apparatus enable reception and display of proper broadcast file data by detecting an error in a specific data block and receiving the specific data block again in a process of receiving digital broadcast file data.

### PRIORITY

This application claims the benefit under 35 U.S.C. §119(a) of a Korean patent application filed in the Korean Intellectual Property Office on Jul. 9, 2007 and assigned Serial No. 2007-0068605, the entire disclosure of which is hereby incorporated by reference.

### BACKGROUND OF THE INVENTION

1. Field of the Invention

The present invention relates to a digital broadcast file data receiving method and a digital broadcast file data receiving apparatus. More particularly, the present invention relates to a digital broadcast file data receiving method and a digital broadcast file data receiving apparatus that help detect an error in a data block of digital broadcast file data and receive the same data block again in order to replace the data block having the error, in a process of receiving digital broadcast file data.

2. Description of the Related Art

The desirability of portable terminals has been rapidly increasing due in large part to their mobility. In their evolution, portable terminals have been expanding their areas of use due to various options for storage and playback of information desired by terminal users, such as an MP2 function, a broadcast display function, a video playback function, and a camera function, while maintaining their mobility.

The above-mentioned broadcast display function of portable terminals enables the use of a broadcast service provided by a broadcasting station while portable terminals are on the move. Due to the advantages of such a mobile service, the broadcast display function of portable terminals is increasingly desirable. In order to provide such a broadcast display function, it is necessary to provide portable terminals with separate broadcast display modules. That is, a portable terminal that provides mobile communication has both a broadcast display module and a mobile communication module to provide the above-mentioned broadcast display function while maintaining its mobile communications function.

Meanwhile, in the above-mentioned broadcast service, there is a limited service area despite the installation of repeaters and the construction of networks and there frequently occurs noise in broadcast file data transmitted from a broadcasting station due to its frequency characteristics. Accordingly, when noise occurs in broadcast file data transmitted from a broadcast station, a portable terminal may not be able to properly decode an image. Therefore, a need exists for a method and apparatus for invalidating broadcast file data having noise, and receiving, decoding, and storing normal broadcast file data.

### SUMMARY OF THE INVENTION

An aspect of the present invention is to address at least the above-mentioned problems and/or disadvantages and to provide at least the advantages described below. Accordingly, an aspect of the present invention is to provide a digital broadcast file data receiving method and a digital broadcast file data receiving apparatus that help detect a data block in digital broadcast file data in which an error occurred and receive the same data block again in order to replace the data block having the error, in a process of receiving digital broadcast file data.

In accordance with an aspect of the present invention, a digital broadcast file data receiving method is provided. The method includes receiving broadcast file data in one or more data blocks, detecting an error in at least one of the received data blocks, receiving at least one normal data block having substantially the same content as the corresponding at least one data block in which the error was detected, and replacing the at least one data block having the error with the corresponding at least one normal data block.

In accordance with another aspect of the present invention, a digital broadcast file data receiving apparatus is provided. The apparatus includes a broadcast receiver module for receiving broadcast file data in one or more data blocks, and a control unit for detecting an error in at least one of the received one or more data blocks and for controlling the broadcast receiver module to receive at least one normal data block having the same content as the corresponding at least one data block in which the error was detected.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a digital broadcast file data receiving system according to an exemplary embodiment of the present invention;

FIG. 2 illustrates a broadcast file data transmitting structure according to an exemplary embodiment of the present invention;

FIG. 3 schematically illustrates a portable terminal according to an exemplary embodiment of the present invention;

FIG. 4 illustrates a unique marker included in a data block according to an exemplary embodiment of the present invention;

FIG. 5 illustrates one example of a screen interface of a display unit according to an embodiment of the present invention; and

FIG. 6 is a flowchart illustrating a digital broadcast file data receiving method according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions may be omitted for clarity and conciseness. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments is to be construed as exemplary only and does not describe every possible embodiment of the invention. Therefore, it should be understood that various changes may be made and equivalents may be substituted for any element of the following illustrated exemplary embodiments of the invention.

Exemplary embodiments of the present invention relate to a digital broadcasting service. In particular, the exemplary embodiments of the present invention include examples of storing broadcast file data provided in a digital multimedia broadcasting service and using the stored broadcast data as a background screen or as an insertion screen during a conversion of channels. However, the present invention is not limited to the examples described herein. When there is an error in broadcast file data received through a broadcasting network, with the broadcast file data being received by units of blocks, the digital broadcast file data received according to the exemplary embodiments of the present invention enable determining if an error occurred in a data block of the digital broadcast file data, downloading of a new data block having the same content and version as the data block having the error, and replacement of the data block by the new data block. To achieve this, it is necessary to repeatedly provide broadcast file data files in units of data blocks in cycles. The broadcast file data may be transmitted according to a transfer protocol (e.g. MPEG02 Unit 6 DSM-CC DATA Carousel). The broadcast file data may include only one data block or more. That is, the number of data blocks may be determined by the amount of broadcast file data. An error in a data block may be determined with reference to an error in an index value, according to an existence of a unique marker value, i.e. an index value that is included in metadata of the broadcast file data. For example, assuming that a plurality of data blocks form one broadcast file data, in the broadcast file data receiving method according to an exemplary embodiment of the present invention, a data block including an index may be detected and received again when there is an error in the index that is included in metadata of the broadcast file data.

The broadcasting communication technology applied for the digital broadcast file data receiving method according to an exemplary embodiment of the present invention may be any one of various communication systems applied to a mobile TV, such as a satellite digital multimedia broadcasting (DMB) system, a terrestrial DMB system, a DVB-H system, a DVB-T system and the like. However, the digital broadcast file data receiving method according to an exemplary embodiment of the present invention is not limited to mobile TV, and may be applied to any communication technology whose data receiving structure repeatedly receives digital broadcast file data in cycles.

The portable terminal described in the exemplary embodiments of the present invention includes a broadcasting communication module, and may be applied to any information technology (IT) equipment and multimedia equipment, such as a mobile terminal, a digital broadcasting terminal, a personal digital assistant (PDA), a smart phone, a 3G terminal, e.g. an international mobile telecommunication 2000 (IMT-2000) terminal, a wideband code division multiple access (WCDMA) terminal, and a universal mobile telecommunication service (UMTS) terminal, a portable internet terminal, a high speed downlink packet access (HSDPA) terminal, and their applications.

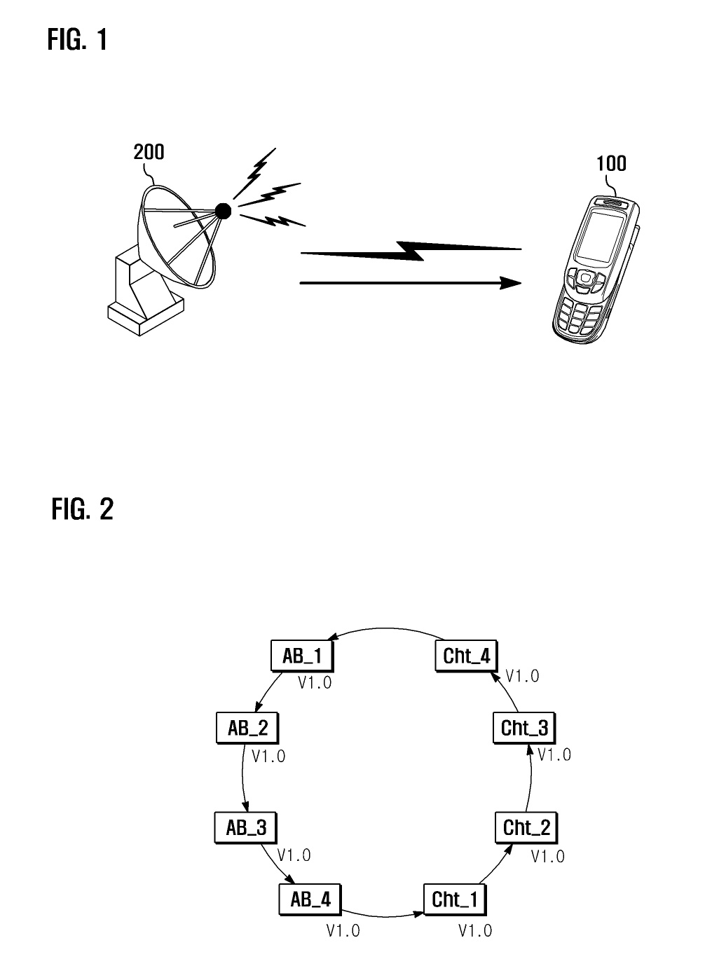

FIG. 1 illustrates a digital broadcast file data receiving system according to an exemplary embodiment of the present invention.

Referring to FIG. 1, the digital broadcast file data receiving system according to the exemplary embodiment of the present invention includes a transmission station 200 that can transmit broadcast file data by units of blocks, and a portable terminal 100 including a broadcast receiver module that can receive data blocks transmitted from the transmission station 200.

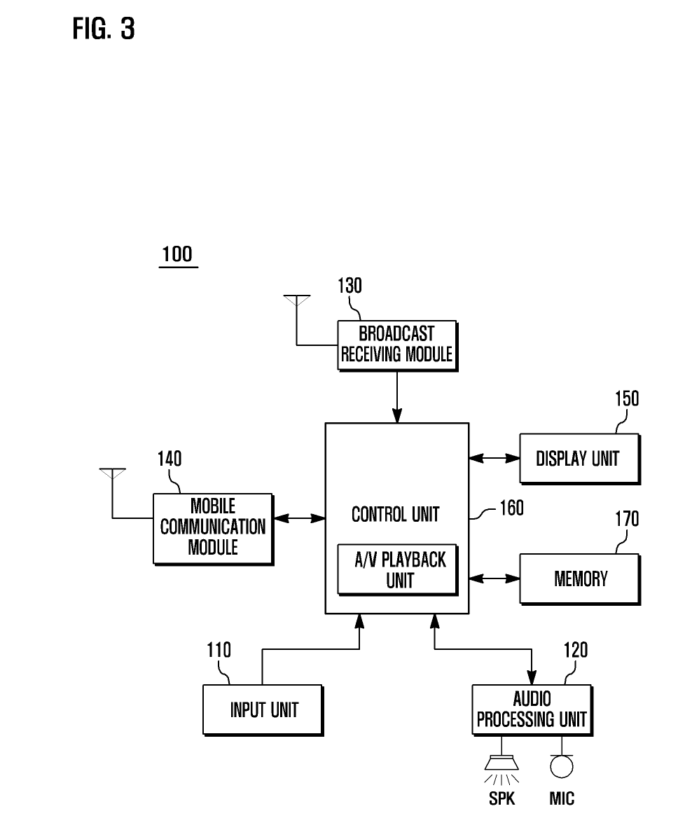

The transmission station 200 divides the broadcast file data into data blocks, encodes and modulates the data blocks, and transmits the encoded and modulated data blocks to the portable terminal 100 through a broadcasting network. The transmission station 200 includes a broadcast transmission server supporting at least one of various communication technologies. For example, the transmission station 200 may transmit broadcast file data divided into data blocks to a terminal or a portable terminal having a satellite DMB broadcast receiver module, based on satellite DMB. The transmission station 200 repeatedly transmits the data blocks. That is, when one broadcast file data is divided into four data blocks, the transmission station 200 sequentially transmits the four data blocks, and when the sequential transmission of the four data blocks is complete, the transmission station 200 sequentially retransmits the data blocks from the beginning. Thus, even if the transmission station 200 starts to download the data blocks at any time point, the same files, i.e. the files having the same version and identifier are repeatedly transmitted to receive all four data blocks after a lapse of a period of time. Hereinafter, the data block transmission technology will be described in more detail with reference to FIG. 2.

FIG. 2 is illustrates a transmission of data blocks according to an exemplary embodiment of the present invention.

Referring to FIG. 2, in the data block transmitting method according to an exemplary embodiment of the present invention, two files, i.e. an audio background (AB) file and a channel transition file are transmitted to the portable terminal 110 through the same channel. The AB file is divided into four data blocks, i.e. AB_1, AB_2, AB_3, and AB_4 to be transmitted and the channel transition file is divided into four data blocks, i.e. Cht_1, Cht_2, Cht_3, and Cht_4 to be transmitted. The eight data blocks are sequentially transmitted, and after transmission of all the data blocks is complete, the transmission of the data blocks is repeated. As a result, the eight data blocks have a ring shape and are repeatedly transmitted on a network. Assuming that all of the eight data blocks have the file version of 1.0, the transmission station 200 continuously transmits the data blocks of version 1.0 as long as the version of the data blocks remains the same. Then, after the transmitted eight data blocks are received by the portable terminal 100 and are stored in a memory, they are displayed on a display unit or are output to an audio processing unit. The portable terminal 100 is configured not to download data blocks having the same version and identifier as data blocks already downloaded in order to reduce a load generated when it repeatedly receives the same data blocks as the eight data blocks that have already been downloaded. However, since the portable terminal 100 examines only the version of the data blocks even if it receives one of the data blocks that cannot be decoded due to an error, it does not download anymore normal data blocks. This is because the portable terminal 100 is configured to receive new data blocks only through a version examination even if it receives a data block having an error. Accordingly, there is a need to address received blocks that have an error and yet pass a version examination. Therefore, a method in which the portable terminal 100 detects a data block having an error in a broadcast file data transmitting structure of the transmission station 200 and replaces the data block having the error with a normal data block, and roles of a terminal for realizing the method will be discussed below.

As described above, the portable terminal 100 examines a unique marker value which is included in metadata of broadcast file data including at least one data block, and determines which data block corresponds to an area in which the unique marker value is not detected in order to replace the data block. Accordingly, when an error has been detected in the received broadcast file data, the portable terminal 100 restores the broadcast file data by replacing the data block having the error. The portable terminal 100 removes a repeated display of a no-mark file or a no-mark area due to a repeated playback of the data block having an error, and supports a reception and playback of normal files. To achieve this, as illustrated in FIG. 3, the portable terminal 100 according to an exemplary embodiment of the present invention includes an input unit 110, an audio processing unit 120, a broadcast receiver module 130, a mobile communication module 140, a display unit 150, a control unit 160, and a memory 170. The mobile communication module 140 may be omitted in the portable terminal 100 because it is an element that can be coupled to the portable terminal 100 for mobile communication.

The input unit 110 includes a plurality of input keys for the input of numbers and letters and a plurality of function keys for setting various functions. The function keys may include direction keys, side keys and shortcut keys that are configured to perform specific functions. The input unit 110 transfers key signals to the control unit 160 that are input for setting functions by a user and for controlling functions of the portable terminal 110. In particular, the input unit 110 according to an exemplary embodiment of the present invention generates input signals for activating the broadcast receiver module 130, input signals for indicating receipt of broadcast file data by the broadcast receiver module 130, and input signals for the switching of channels during reception of a broadcast, and transfers them to the control unit 160.

When audio information is included in broadcast file data during the playback of the broadcast file data, the audio processing unit 120 outputs the audio information through a speaker (SPK). The audio processing unit 120 receives an audio signal from a microphone (MIC) and transfers the audio signal to the control unit 160 during a mobile communication, such as voice communication, using the mobile communication module 140.

The broadcast receiver module 130 is a communication module that creates a broadcasting network and a communication channel and receives broadcast file data transmitted from the transmission station 200 by units of blocks. The broadcast receiver module 130 may independently download data blocks based on a protocol for reception of data blocks, regardless of the setting of a channel for receiving a broadcast program. Further, the broadcast receiver module 130 receives signals corresponding to a formal channel, i.e. a broadcasting program in addition to broadcast file data received by units of blocks, and outputs them under the control of the control unit 160. For example, the broadcast receiver module 130 receives broadcast information of a program through a channel and outputs it, and at the same time, receives broadcast file data transmitted by units of blocks based on a protocol. The broadcast file data may be used as information for a background screen or a channel switching screen of the broadcast program and for an upgrade of the portable terminal 100. That is, the broadcast file data may include a still image, a moving image, audio information, upgrade information for the portable terminal 100, and the like. The broadcast receiver module 130 is a unidirectional communication module for receiving broadcasting signals through a broadcasting network. The broadcast receiver module 130 includes elements that are arranged in reverse order of those of the transmission system of the transmission station 200 transmitting broadcast information, and demodulates and decodes the received broadcast signal. The broadcast receiver module 130 may transfer the decoded signal to the display unit 150 via the control unit 160. In particular, if there is an error in the received broadcast file data, the broadcast receiver module 130 determines which of data blocks corresponds to an area having the error under the control of the control unit 160, and downloads the data blocks having the error based on the version and identifier of the data block. Therefore, the received data block is replaced by a normal data block, so that it can be normally displayed. When the broadcast file data includes only one data block and that data block has an error, the data block may be received again and may be replaced with a normal data block, without any additional data block determining process.

The mobile communication module 140 provides the mobile communication function of the portable terminal 100. The mobile communication module 140 creates a mobile communication network and a communication channel under the control of the control unit 160, to transmit voice data and image data of the portable terminal 100, and to receive voice data and image data and output them.

The display unit 150 displays broadcast file data received by the broadcast receiver module 130 and video information included in a channel. When an error has occurred in one data block while broadcast file data is being displayed, the display unit 150 may display the broadcast file data including the data block having the error until the data block having the error is replaced by a normal data block. The display unit 150 may be a touch panel for creating a touch event, in which case, it may function as input unit 110. A screen interface displayed on the display unit 150 will be described in detail with reference to the accompanying drawings.

The memory 170 stores application programs necessary for various functions provided by the portable terminal 100, including application programs necessary for operation according to exemplary embodiments of the present invention. That is, the memory 170 stores programs for activation of the broadcast receiver module 130 and programs for activation of the mobile communication module 140, and an A/V playback unit for the playback of broadcast file data received by the broadcast receiver module 130 and data included in a channel, and loads them in the control unit 160 under the control of the control unit 160. The memory 170 may temporarily store the received broadcast file data. That is, the memory 170 may buffer broadcast signals upon the reception of broadcast information. The memory 170 may include a program section and a data section.

The program section stores an operating system (OS) for booting the portable terminal 100, a program for activation of the broadcast receiver module, an A/V playback program for playback of broadcast information, application programs for other optional functions of the portable terminal 100 such as a camera function, a sound playback function, and an image playback function. In particular, the program section stores an error detection program for detecting whether there is an error in the received broadcast file data and an A/V control program for controlling replacement of the data block corresponding to an area having the error by a normal data block. The error detection program and the A/V control program are stored in the memory 170, and are loaded in the control unit 160 upon activation of the broadcast receiver module 130 to process the received data blocks. On the other hand, when the portable terminal 100 activates the functions in response to a request of a user, it provides the functions using corresponding application programs under the control of the control unit 160, respectively.

The data section is a section where data created when the portable terminal 110 is used is stored. User data related to other various optional functions, such as images and moving images photographed using the above mentioned camera function, phone book data, audio data, and content, or information corresponding to the user data may be stored in the data section. In particular, the data section may also store or buffer data blocks received by the broadcast receiver module 130. When there is an error in any data block of broadcast file data, or a data block having an error is received, the data block having the error may not be stored in the data section and may be deleted. To achieve this, the data section may include areas for buffering and storing the data blocks received by the broadcast receiver module 130, respectively. The data section may continue to store the data block having the error until a normal data block is received, and may delete the data block having the error upon reception of the normal data block. The data block stored in the data section may be displayed on the display unit 150 under the control of the control unit 160 regardless of occurrence of an error. Meanwhile, the data section stores unique markers for the detection of an error in a data block. Such a unique marker refers to a single marker that defines a metadata value of a file created through a decoding process of a data block. Only one unique marker exists in a file, e.g. a JPEG file, and an error of a file may be determined according to the existence of the unique marker. The unique marker includes the marker FFD8 informing the start of one broadcast file data and the marker FFD9 informing the end of one broadcast file data, and further includes various markers defining broadcast file data, such as a unique marker regarding a quantization table and a unique marker informing the start of a scan line. The unique markers have specific bit values respectively, and the data section stores the unique markers in the form of tables and provides them for an error detection program loaded according to the activation of the broadcast receiver module 130. As illustrated in Table 1 below, the unique marker includes various markers. Although Table 1 expresses the unique marker as a marker included in a JPEG image, the present invention is not limited thereto. That is, an image compressed and encrypted by various compression technologies includes an index value corresponding to a unique marker. Accordingly, an error may be detected in one broadcast file data by applying the same error detecting method as that described herein.

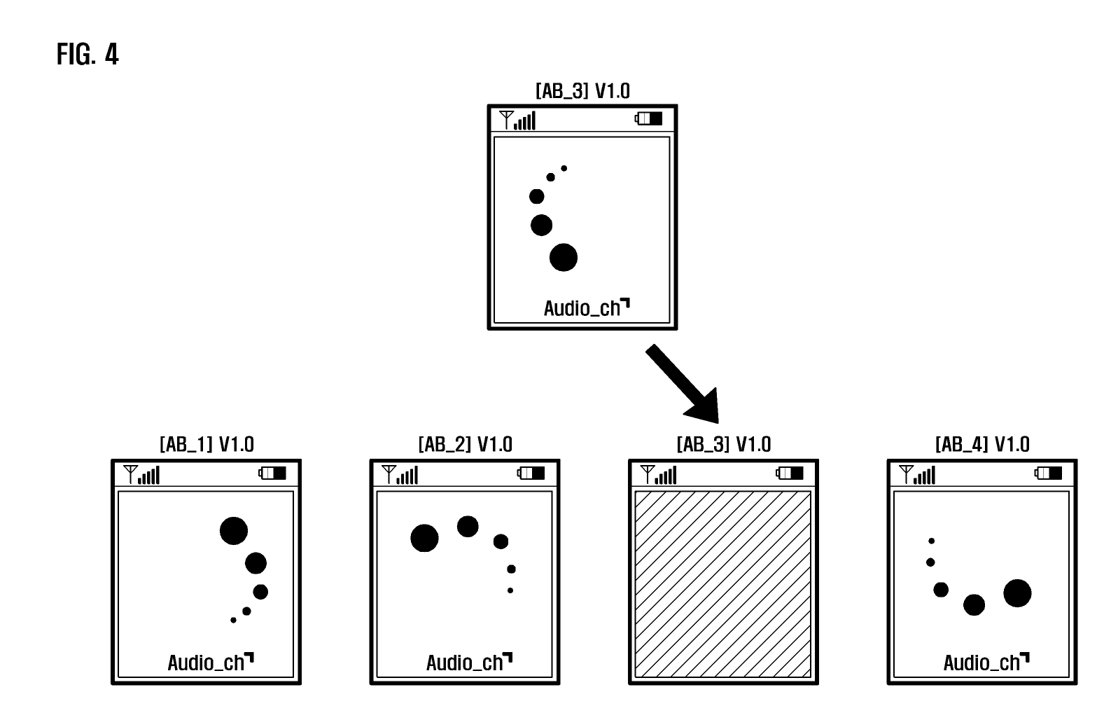

The control unit 160 controls the overall operation of and signal flows between internal sections of the portable terminal 100. When the control unit 160 activates the broadcast receiver module 130, it activates an error detecting program and an AV playback program and detects an error occurring in a received data block using the error detecting program. The control unit 160 controls the received data block to be displayed using the A/V playback program. When the portable terminal 100 provides mobile communication, the control unit 160 may have functions of a modem and a codec used in compression of an image. In order to detect an error in the received data block, as illustrated in FIG. 4, the control unit 160 determines the existence of unique marker values provided from the memory 170 in broadcast file data decoded by units of bits. The control unit 160 compares various unique marker values included in broadcast file data with values obtained by decoding the broadcast file data, and determines the correctness of unique marker values. Since this operation may be performed not only by a main processing operation of the portable terminal 100 but also by a background processing operation, it may also be performed without interfering with other functions of the portable terminal 100 and without time limits. Moreover, since there is no need for additional speed due to a background processing operation, the portable terminal 100 may search for a unique marker in units of bits without any increase in load due to a rapid search operation.

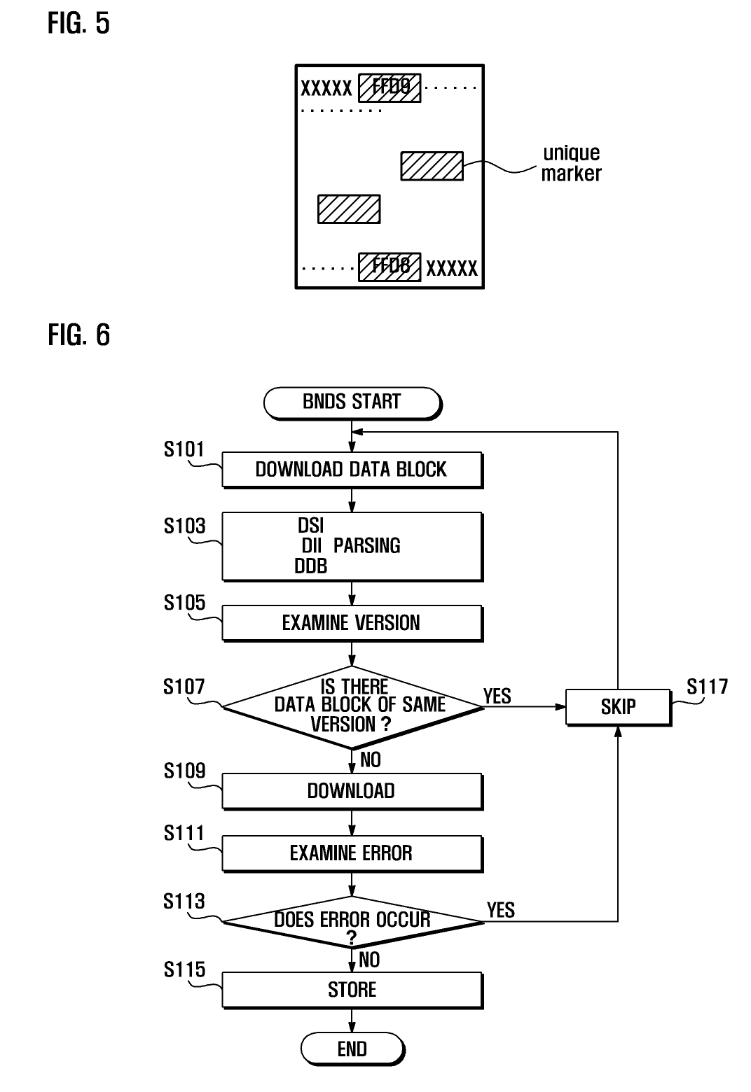

FIG. 5 illustrates an example of a playback screen interface corresponding to the reception of broadcast file data by a portable terminal 100 according to an exemplary embodiment of the present invention.

Hereinafter, an example will be described in which the display unit 150 of the portable terminal 100 plays back audio background (AB) data of broadcast file data transmitted from the transmission station 200.

For the purpose of the deception, it is assumed that each of four data blocks is broadcast file data corresponding to a video or an image. Accordingly, the four data blocks are continuously displayed to appear as one moving image.

Referring to FIG. 5, the display unit 150 of the portable terminal 100 decodes received data blocks, i.e. AB_1, AB_2, AB_3, and AB_4 to create four broadcast file data, and displays the four broadcast file data, respectively. The four broadcast file data may correspond to continuous still images of a moving image. The display unit 150 displays an image corresponding to AB_1 Version 1.0 (V1.0) data for a time period, and then displays an image AB_2 V1.0 data for a time period. AB_3 V1.0 data and AB_4 V1.0 data are then respectively displayed for respective time periods in the same way. After displaying all images corresponding to AB_1, AB_2, AB_3, and AB_4 data, the display unit 150 may repeatedly display the data from AB_1 data to AB_4 data again. When there is an error in the AB_3 data in the received AB_3 data block, the display unit 150 may not display the image corresponding to the data block but may instead treat the image as a blackout. Then, the control unit 160 detects the occurrence of an error in the AB_3 data block, and receives a normal AB_3 V1.0 data block using the broadcast receiver module 130. The broadcast receiver module 130 deletes the AB_3 V1.0 data block having an error and plays back an image corresponding to a normal AB_3 V1.0 data block. The control unit 160 detects the occurrence of an error in broadcast file data according to the existence of marker values that are included in metadata of the broadcast file data created by decoding the data block. When there is an error in the broadcast file data, the control unit 160 controls the broadcast receiver module 130 to again receive the data block having the same version and identifier as the data block having the error. While it has been described that an entire broadcast file data corresponding to the AB_3 V1.0 data block is not displayed when there is an error, according to another exemplary embodiment of the present invention, only the portion of the broadcast file data corresponding to the AB_3 V1.0 data block that is damaged due to a frequency environment may instead not be displayed. Accordingly, it is preferable that the control unit 160 detects an error by examining all unique markers that are to be included in the AB_3 V1.0 broadcast file data. However, considering an increase in a load of the portable terminal 100, an error may be detected by selecting a specific one of the unique markers that are included in the broadcast file data.

Until now, the digital broadcast receiving system according to an exemplary embodiment of the present invention has been discussed. Hereinafter, a broadcast file data receiving method that enables the transmission and reception of data blocks, detection of an error, and restoration of a data block having an error in the digital broadcast receiving system will be described with reference to the accompanying drawings.

FIG. 6 is a flowchart illustrating a broadcast file data receiving method according to an exemplary embodiment of the present invention.

Referring to FIG. 6, first, the broadcast file data receiving method according to the exemplary embodiment of the present invention allows the control unit 160 to start a broadcasting network download service (BNDS). The BNDS is a technology for the reception of broadcast file data and the processing of files using background processing. That is, The BNDS refers to a technology that enables a terminal to periodically download necessary files and, according to a designation of a user, detect an error from the downloaded files, restore the file having an error, and store the restored file, regardless of the various functions performed in the foreground by the portable terminal 100.

Thereafter, in step S101, the control unit 160 prepares for the downloading of data blocks. That is, the control unit 160 performs a channel frequency setting operation for activating the broadcast receiver module 130. Then, the control unit 160 may establish a channel for receiving the data blocks. The control unit 160 may receive the broadcast file data together with audio/video (A/V) information through the same channel. Further, the control unit 160 controls the broadcast receiver module 130 to download program information that is to be received by the broadcast receiver module 130 through a channel, and may set the broadcast receiver module 130 to allow the broadcast file data received in units of data blocks to be downloaded through a separate file transfer channel. The control unit 160 buffers some or all of data blocks upon activation of the broadcast receiver module 130.

In step S103, the control unit 160 parses information based on a data block transfer protocol, such as Download Service Initiating (DSI), Download Information Identification (DII), and Download Data Block (DDB). The information is included in a data block transmitting structure. The DSI defines DII blocks and the DII defines DDB blocks. That is, at least one DDB creates broadcast file data, and multiple broadcast file data are included in the DII. The DSI may include multiple DIs. The control unit 160 receives the DSI to receive data blocks, extracts the DII based on the received DSI, and receives the DDB based on the DII again. The control unit 160 may check version information of the DDBs based on the DII and the DDB in step S105.

Then, in step S107, the control unit 160 determines the existence of a data block whose version is identical with the detected version. That is, the control unit 160 checks the stored data block in the memory 170, and checks the identification of the versions of the stored data block and the currently received data block when the data block is stored in the memory 170.

When there is no data block having the same version as that of the currently received data block in step S107, the control unit 160 downloads the data block in step S109. That is, when there is no data block having the same version as that of the currently received data block, the control unit 160 determines that the currently received data block is a new data block and downloads it. In other words, in step 101, the control unit 160 downloads only some information of the data block, i.e. a section including the version information of the data block in order to efficiently download the data block, and may download the remaining portion of the data block after comparing the version information with version information of a previously stored data block.

Then, in step S111, the control unit 160 detects an error in the data block. After completing the download of the data block, the control unit 160 converts the data block into broadcast file data by decoding the data block. The broadcast file data is decoded in units of bits, and a bit value corresponding to a unique marker exists in the metadata of the broadcast file data. Thus, the control unit 160 checks a normal arrangement of unique markers in the metadata of the broadcast file data by both running an error detection program stored in the memory 170 and loading the unique marker table stored in the memory 170. That is, the control unit 160 determines if the unique markers are included in the broadcast file data, and then determines if there is an error in the broadcast file data based on the determination that the unique markers are included in the broadcast file data. Then, when the control unit 160 determines that there is no error in the broadcast file data in step SI 13, it stores the downloaded data block or the decoded broadcast file data in the memory 170 in step S115.

On the other hand, when there is a data block having the same version in step 107, the control unit 160 goes to step S117 and skips downloading the data block having the same version to which a version examination is performed. Then, the control unit 160 deletes information received for the version examination. In other words, the control unit 160 examines a section where the version information of the data blocks is stored and the version information is extracted in step S101, and when there is no data block having same version information as the version information, data blocks are controlled not to be downloaded.

When there is an error in the downloaded data block in step S113, the control unit 160 goes to step S 117 and skips storing the downloaded data block. Even if there is an error in some or all of the broadcast file data obtained by decoding the data block, the control unit 160 may control the display unit 150 to display the broadcast file data with the error or errors being included in the broadcast file data.

As mentioned above, in the broadcast file data receiving method according to an exemplary embodiment of the present invention, an error in broadcast file data may be detected from the broadcast file data that is repeatedly transmitted in units of data blocks and the data block having an error may be replaced by a normal data block in order to correct a display error in a process of continuously and repeatedly playing back broadcast file data.

As apparent from the above description, exemplary embodiments of the present invention provide a broadcast file data receiving method and a broadcast file data receiving apparatus that enable detection of a section having an error during the reception of broadcast file data and the correction of a repeated display error by replacement of the section by normal data.

While the invention has been described with reference to certain exemplary embodiments thereof, it will be understood by those skilled in the art that various changes in form and details may be made therein without departing from the spirit and scope of the invention as defined by the appended claims and their equivalents.

What is claimed is:

1. A digital broadcast file data receiving method, the method comprising:
receiving broadcast file data in one or more data blocks;
detecting an error in at least one of the received one or more data blocks;
receiving at least one normal data block having substantially the same content as the corresponding at least one data block in which the error was detected; and
replacing the at least one data block having the error with the corresponding at least one normal data block.

2. The method of claim 1, wherein the detecting of the error comprises:
generating the broadcast file data by decoding the received one or more data blocks;
examining the generated broadcast file data for a unique marker; and
determining the error according to an existence of the unique marker.

3. The method of claim 2, wherein the examining of the unique marker comprises:
detecting the broadcast file data by units of bits; and
examining for the existence of the unique marker corresponding to a detected bit.

4. The method of claim 1, further comprising playing back the broadcast file data including the at least one data block having the error before replacing the at least one data block having the error with the corresponding at least one normal data block.

5. The method of claim 1, wherein the receiving of the broadcast file data in one or more data blocks comprises background processing.

6. The method of claim 1, wherein the receiving of the broadcast file data in one or more data blocks comprises:
receiving an area including version information of a data block;
detecting the version information;
checking for an existence of any data block downloaded having the same version and identifier as the data block; and
downloading the data block when a data block downloaded having the same version and identifier as the data block does not exist.

7. The method of claim 1, wherein the broadcast file data comprises background information and channel conversion information of a broadcast program, and upgrade information of a terminal.

8. The method of claim 1, wherein in the receiving of the broadcast file data in one or more data blocks, one or more data blocks of the same version are repeatedly transmitted for a time period.

9. A digital broadcast file data receiving apparatus, the apparatus comprising:
a broadcast receiver module for receiving broadcast file data in one or more data blocks; and
a control unit for detecting an error in at least one of the received one or more data blocks and for controlling the broadcast receiver module to receive at least one normal data block having the same content as the corresponding at least one data block in which the error was detected.

10. The apparatus of claim 9, further comprising a memory for storing the received one or more data blocks, the at least one data block having the error being replaced by the corresponding at least one normal data block under the control of the control unit when the memory receives the corresponding at least one normal data block.

11. The apparatus of claim 9, wherein the memory stores at least one unique marker included in the broadcast file data.

12. The apparatus of claim 11, wherein the control unit checks for an existence of a value corresponding to the unique marker in the broadcast file data, and determines an occurrence of an error in the at least one data block corresponding to the broadcast file data according to the existence of the value corresponding to the unique marker.

13. The apparatus of claim 12, wherein the control unit examines the broadcast file data by units of bits and determines an existence of a bit value corresponding to the unique marker.

14. The apparatus of claim 9, further comprising a display unit for displaying the broadcast file data generated by decoding the received one or more data blocks.

15. The apparatus of claim 14, wherein the display unit displays the broadcast file data including the at least one data block having the error.

16. The apparatus of claim 9, wherein the control unit decodes the broadcast file data and receives the at least one data block again according to the occurrence of the error through a background processing.

17. The apparatus of claim 9, wherein the control unit extracts version information of the one or more data blocks, checks for an existence of any data block having the same version and identifier as any data block in the memory, and when a data block having the same version and identifier as those of the at least one data block does not exist in the memory, the control unit controls the memory to download the data block.

18. The apparatus of claim 9, wherein the broadcast file data includes background information and channel conversion information of a broadcast program, and upgrade information of a terminal.

19. The apparatus claim 9, wherein the broadcast file data includes one or more data blocks having the same version that are repeatedly transmitted for a time period.
